(19) United States
(12) Patent Application Publication
(10) Pub. No.: US 2015/0073938 A1
(43) Pub. Date: Mar. 12, 2015

(54) CHANNEL PARTNERS SYSTEM AND METHOD

(71) Applicant: Digital River, Inc., Minnetonka, MN (US)

(72) Inventors: Michael Jay CHUMA, Cologne, MN (US); Michael Patrick FRENCH, Monaca, PA (US)

(21) Appl. No.: 14/314,976

(22) Filed: Jun. 25, 2014

Related U.S. Application Data
(60) Provisional application No. 61/839,011, filed on Jun. 25, 2013.

(51) Int. Cl. G06Q 30/06

(52) U.S. Cl. CPC G06Q 30/0613
USPC 705/26.41

(57) ABSTRACT

Disclosed system, method and related apparatus are described for the management and operation of channel partners relationship and sales transactions in a distributed computing environment over the network, such as the Internet or other type of network. The disclosed system and method allows centered management of complex parties including inter and intra sales parties. An exemplary system implementation includes a party management module for managing and developing party relationships and event management module for generating a plurality sets of events and associated triggered programs. A channel commerce module of the disclosed system provides channel transaction related accounting based on the event and the relationship between the parties including commission calculation and distribution.

This application claims the benefit of U.S. Provisional Patent Application No. 61/839,011 filed on 25 Jun. 2013, titled “Channel Partners System and Method,” which is incorporated herein by reference.

### FIELD OF THE INVENTION

The present invention relates to ecommerce, and more particularly, relates to a system and method for developing and managing B2B (business to business) channel partners in a distributed computing environment over the network, such as the Internet or other type of network.

### BACKGROUND OF THE INVENTION

While ecommerce growth and opportunity is undeniable, seller's offline channel partners have remained critical to sales, fulfillment, service, support, and retention. For example, channel partners' revenue often represent two to six times of a firm's direct revenue, they deliver essential value-added services to sellers and end-customers, provide economic value-at-scale for the long tail and extend reach into new segments and geographies. Therefore, sellers still have various interactive channel partners to promote their product or services. The channel partners are affiliate entities such as resellers, distributors, independent software vendors, and the like.

Under such diverse commerce transaction environments, many sellers go to market through both 1) an online commerce store, the “online commerce channel”, and 2) an offline network of resellers, distributors, and independent software vendors—collectively the “channel partner”. However, a fundamental conflict exists between 1) and 2): offering an online commerce channel risks alienating and taking revenue from the channel partner. This restricts a seller's ability to meet the needs of its end-customers and its partners, and limits growth its revenue.

Further, conventional online commerce systems are built to support orders that involve only single layered: two parties—the buyer and the seller. This is a fundamental limitation in supporting the channel partner which, by definition, involves multiple parties on each order, and multiple parties on the activities are related to initially acquiring the customer and following the order, including providing service and support to the customer and engaging in compensation-worthy activities to retain the customer.

Further, the prevalence of the ecommerce over the network, such as the Internet or other type of network, has introduced new methods for provisioning a product that include use of the product over the network which is provisioned and managed remotely. Previously, the provisioning are fulfilled through shipment, download, or on-premise operation. The new methods for provisioning is often referred to as delivery “as-a-service” or a “cloud service”. However, the new methods for provisioning still leave the necessity of the offline network of channel partners. For example, while the actual purchase and fulfillment of the software may be delivered by the seller directly to the customer, the vendor business still relies on its channel to provide service and support to the end-customer.

Various systems exist for developing and managing channel partners over the network, such as the Internet or other type of network. With these systems, the channel partners may fulfill the order from users, and the seller such as the manufacturer or publishers may collect data from the transaction to manage the channel partners. In addition, the systems, in supporting process for order and management, may provide separate administrative tools for sellers and channel partners. The channel partner systems are all separate and out-of-sync. This disparate information from various channel partner systems makes it difficult for the seller to develop and manage channel partners in ecommerce environment. Further, conventional online commerce systems are not built to track the activities performed by the channel partner (on behalf of the seller) in this capacity and are not equipped to provide a seller with a scalable, configurable means through which it can compensate partners for these activities. Accordingly, a need exists for an improved method and apparatus for channel partners and commerce management in ecommerce environment.

### SUMMARY OF THE INVENTION

With the advent of disruptive technologies and processes, such as cloud services and virtualization, channel partners have had to focus on providing high value services to remain profitable, relying upon discounts from sellers. This pressures both channel partners and sellers to change their interaction model to focus on efficiency. In order to become end-customer and efficiency focused, there is need to improved method and systems within conventional sales network of channel partners.

The seller has attempted to solve this problem through multiple solutions, however, those solutions have been internal operations focused and they have not taken steps to address the sustained complexity of an order flow across multiple parties in which a business buyer can purchase products through a broad range of multi-tiered, disconnected channels. For example, creating an order and managing it to goods fulfillment and financial settlement across channel partners typically involves multiple separate legal entities, multi-part processes for handling transactions, and various systems at work in each entity, and as a result: a lack of timely fulfillment and settlement, incomplete information exchanged between parties, and lack of timely information on status and performance. The present disclosed invention reduces the complexity and provides a combined system and method which grants the ability for sellers to engage and involve its channel partner in direct-to-customer online commerce transaction lifecycle—from demand generation and marketing, the commerce shopping experience and order fulfillment, to post-sale support and the related channel partner activities.

The present invention incorporates configurable event tracking, automated multi-party event attribution, compensation calculation based on events both native and non-native to the commerce system, and an integrated payment service that performs payments to partners on the sellers behalf, and automates financial reconciliation with the business. This set of capabilities are provisioned through a multi-tenant web-based administrative portal for a seller, a web-based collaboration portal for its channel partners, and an integration services layer that incorporates HTTP APIs and FTP transfer to support open and scalable integration across processes and system.

The functionality of the present invention may be described in terms of three major sets of modules of party management, universal event management, and channel commerce, and related commercial methods. The party management module functions generating party identifier (ID) and gathering, storing, categorizing and distributing party's attribution ID. The universal event management processes for receiving and recording Event transactions, accompanied by the appropriate party's attribution ID. The channel commerce module works for co-branding between sellers and channel partners. These modules can be the separate individual computer systems or individual applications on one system that interact with each other. The modules may be implemented differently upon sellers or partners activities or commerce environments.

### BRIEF DESCRIPTION OF THE DRAWINGS

FIG. 1 illustrates an exemplary block diagram of direct or indirect multichannel market model which may be implemented in practicing present invention;

FIG. 2 is a diagram of a computing environment capable of implementing the process and method of the present invention;

FIG. 3A is a block diagram illustrating hierarchical data structure of multiple users at company for intra-organization;

FIG. 3B is a block diagram illustrating hierarchical data structure of attributes to sales person at company for intra-organization;

FIG. 4A is a block diagram illustrating hierarchical data structure of multi-tier distribution for inter-organizations;

FIG. 4B is a block diagram illustrating hierarchical data structure of relationship-based end-customer incumbent attribution for inter-organization;

FIG. 5 is a block diagram illustrating a tree data structure for operating multi-site model for a company using hierarchical data structure;

FIG. 6 is a block diagram illustrating of data model that may be used in an event management system;

FIG. 7 a flow chart illustrating a process of purchasing transaction and commission payment in accordance with an embodiment of the present invention;

FIG. 8 is a block diagrams illustrating workflow of co-branding engine;

FIG. 9 is a block diagrams illustrating data model in depicting co-branding engine;

FIG. 10 is a block diagrams illustrating data table model to implement theme of partner record on co-branding engine; and

FIG. 11 is a block diagrams illustrating workflow of partner log-in and review process in co-branding engine.

### DETAILED DESCRIPTION

The present disclosed system and method embraces the benefits of the conventional channel model and the efficiency of an online, direct-to-customer buying model. For a seller, present disclosed system and method provides more time to a seller for growing revenue and the channel partners and less time for administrating channel management. By using the present invented system, a seller can understand detailed channel partner's performance in real-time and provide total transparency to channel partners. Further, a seller can offer to end-customers a “direct” buying experience without cutting out partners. For channel partners, the partners are ease of doing business and more focus on core competency and have a new capability to market and sell online, growing revenue and offering a customer-centric experience. The partner also can retain the ownership of the end-customers and transparency to their activity.

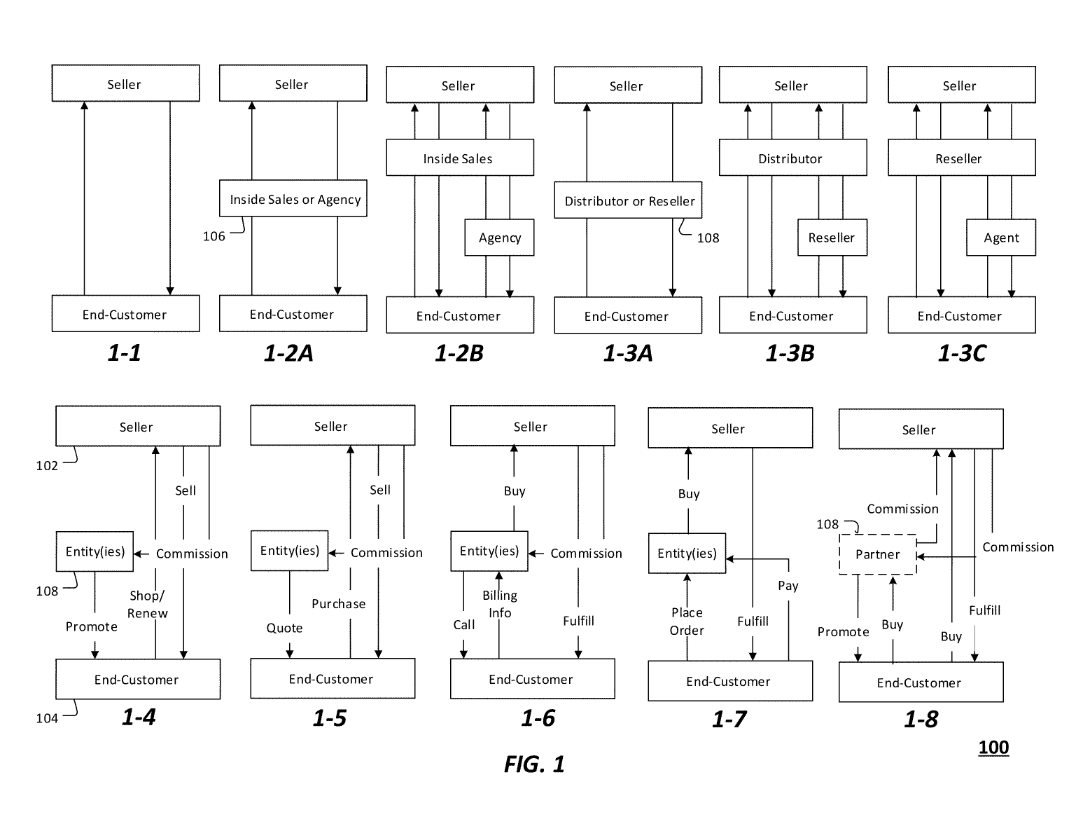

The various models among end-customer, channel partners and sellers are illustrated in FIG. 1. Referring to FIG. 1, the present disclosed system and method can be implemented the direct model by communicating between seller 102 and end-customer 104 through 126 and 127. The present invention may be also implemented to indirect and multichannel model by communicating through 124 and 125. The entities 106 may be inside sales personnel or agency, distributors, or resellers. The entities 106 can be multiple layers.

Further, one of the embodiments in current invention may be implemented as hybrid direct models. For example, seller 102 and end-customer 104 can directly communicate for purchasing and fulfillment through 126 and 127. For this transaction, at the same time, the entities 108 can give quote and suggest promotion to end-customer 120, and then entities can have commission from a seller 102 for this transaction. The end-customer also can choose make the purchase 121 through entities 108 or to the seller 102 directly. The party management system, event management system and channel commerce system are the core functions to implement these models.

Throughout the specification and claims, the following terms take the meanings explicitly associated herein, unless the context clearly dictates otherwise.

The term “vendor” is interchangeable with “seller” and refers to the business entity who is typically the original source of the finished good which is ultimately sold to the end-customer. The term “party” or “parties” means a person or business entity which is involved in a sale or related activities. The term “event” means a subset of the possible outcomes from parties' activities during transaction. The term “partner” and “channel partner” are exchangeable meaning in this document.

### Party Management

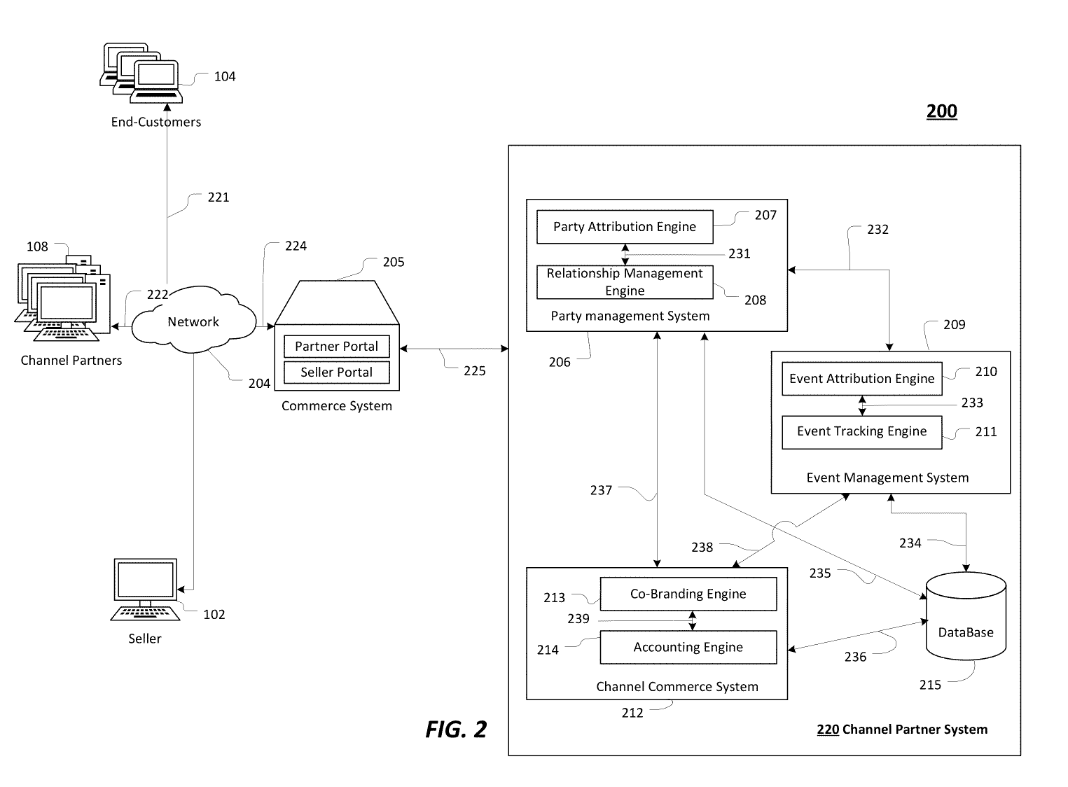

Referring to FIG. 2, the party management system 206 houses and manages profile data and attributes of the parties involved in commerce transactions. A seller uses this module 206 to store and manage information about its consumers, customers, partners, internal business divisions as well as sub-parties who may work for or do business with those parties, such as employees, contractors, or consortiums of such sub-parties.

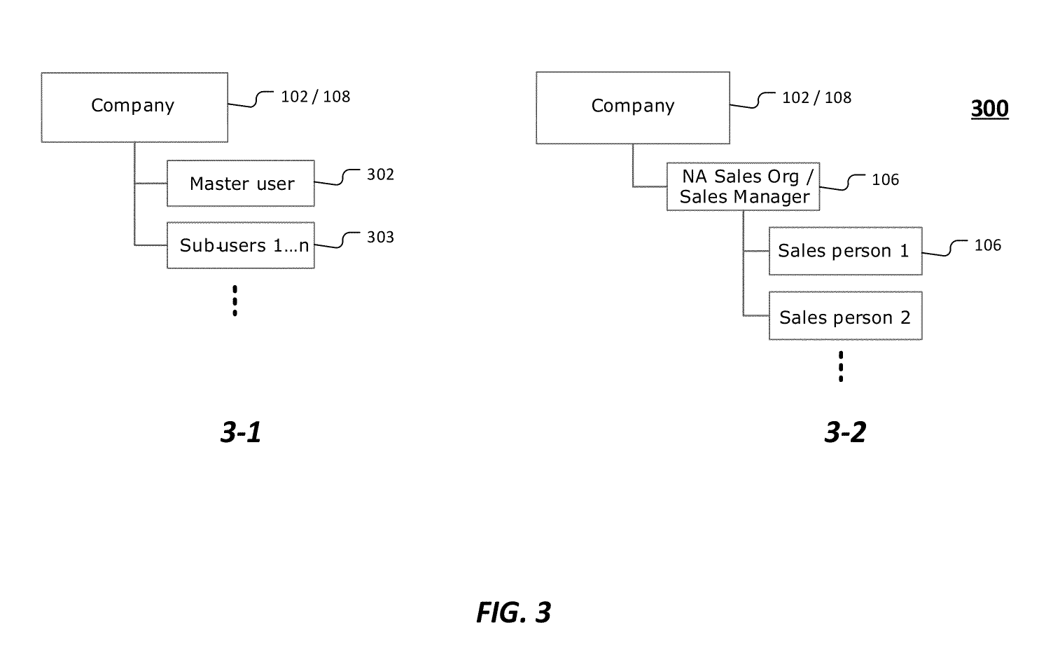

This party attribution engine 207 in party management system 206 organizes all parties under a single common data model and structure and utilizes “types” to represent a set of configurable business rules that determine the roles of the parties of such a type in a transaction through interaction with relationship management engine 208 through 231. These rules allow a given single party to act in multiple or limited roles, such as one party designated as a “company” and also designated as a “reseller” and “servicer” of the seller's product or service as illustrated in FIG. 2. FIG. 3A or FIG. 3B, who is paid by the seller for the services they perform. Another type may indicate a given party is a “sales person” or “referrer” employed by a channel partner, and for whom transactions are assigned and credited for her role in referring an end-customer to purchase from the seller, but who is not directly paid by the seller for this referral—the seller instead paying the channel partner company

This capability solves the unique problem specific to combining online commerce and the channel partner in that a given party will play varying and multiple roles depending on the nature of the specific transaction. This unified structure, rather than maintaining a separate system and record for each transactional role (such as customer, partner, vendor, contact, agent, associate, etc.) provides the broadly varying nature of each commerce transaction to act as the organizing principle for the role of a given party on that transaction.

During the sales transaction in FIG. 2, the party attribution engine 207 captures commerce-specific party attributes when end-customers' activity generates a transaction through network 204. The captured data configures and is customized in party attribution engine 207. The data are arranged by specific attribution identifiers. Each party has two attribution identifiers (IDs). One is a system-generated unique identifier, and one that is a unique identifier, specified by the seller, with a specific meaning and purpose to the seller. The latter, for example, an identifier from the seller's primary back office system. The attribution IDs are used to “tag” one or more parties to any event or commerce transaction that is capture and recorded by the party management module 206. Attribution IDs can be consumed and used for attribution on any transaction that can be transmitted to the system 220. For example, there is transaction that takes place when an end-customer clicks on an HTML link or “digital assets” such as a banner ad in end-customer's system 104 which shows the link or content that is managed and published by the system, a page view, a sale recorded by the commerce platform like 205, a sale recorded by a separate 3^{rd} party system, and the send of an email.

The relationship management engine 208 (multi-system identification system-MIDS) is mapping of parties in the system to corresponding records in multiple other systems, and the use of those other systems' identifiers to interact with the system via all supported integration and tracking methods. Through the engine 208, this capability solves the unique problem specific to combining online commerce and the channel partner in that multiple parties may need to interact at various stages of a transaction or series of transaction using source systems that are otherwise not interoperable with a conventional commerce system, requiring resource intensive customization. With appropriate permissions, the seller or any party authorized by the sellers may interact with the system using any of the IDs assigned in the relationship management engine 208. The relationship management engine 208 avoids the need for each of parties to maintain a separate mapping of the system which—an approach that is not cost-effective or scalable to very large: 10s, 100s, or 1000s of thousands of parties.

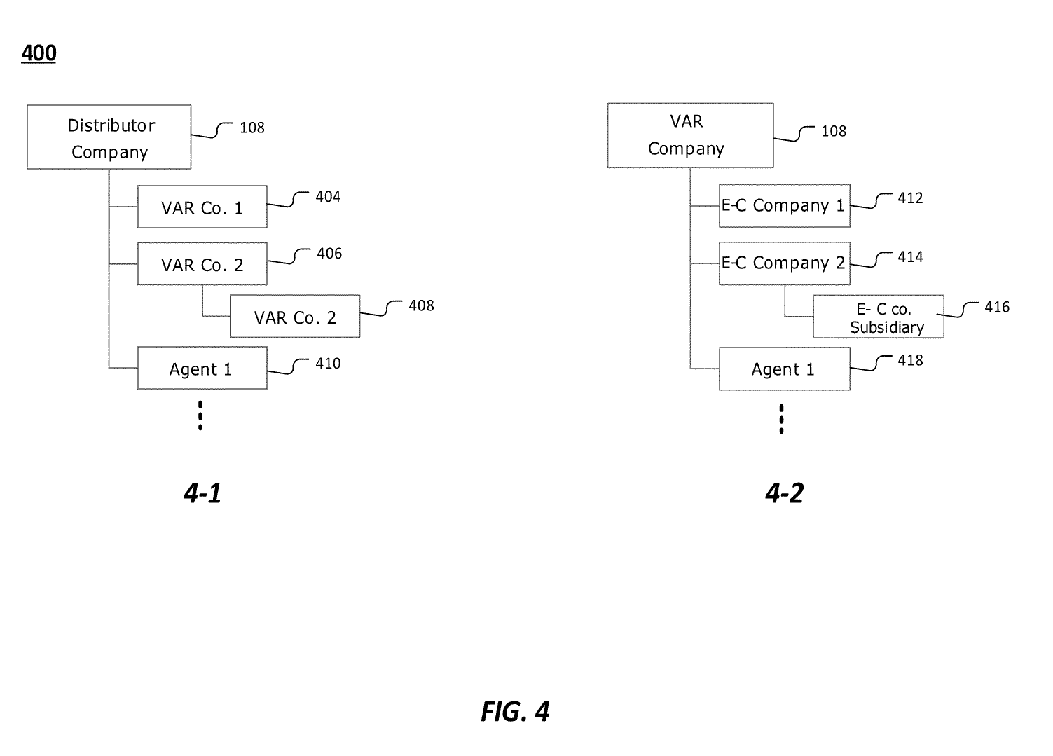

Channel partners 108 can access through network 204 and partner portal system by their system or other apparatus which provide the function to access the system 220. To implement managing complex parties, the system 220 generates hierarchical data model using relationship management engine 208 in FIG. 2. The data model organized parties into both intra-organizational FIG. 3A, and FIG. 3B, and inter-organizational relationships FIG. 4A and FIG. 4B, and then use a combination of party type and parties in a hierarchy relationship to automate multi-party attribution in real-time with an event or commerce transaction.

A channel partner has multiple resources administering or managing their relationship with the vendor, each of whom may perform different functions or have different permission. For example, a channel partner named a “company” in FIG. 3A assigns a master user 302 to administrate their relationship, and may assign sub-user 304 with personalized view of status in relationship and commerce transaction. The company can be a seller 102 or a channel partner 108. Referring to FIG. 1 and FIGS. 3A and 3B, for the other example, a company 102 or 108 has a sales organization in its company and wishes to track commissionable events to individual sales people and sales organizations. The company 102 or 108 can set-up its sales organization and sales person 106 in multi-level deep. In this hierarchical structure, parent party 102 or 108 can see children's states 106 including roll-up or broken-out.

A seller organizes their channel partners into multiple tiers in inter-organization with a distributor or master VAR (value added reseller) organized as a parent of a set of VARs or independent agents. FIG. 4A and FIG. 4B illustrate hierarchical relationship model between companies, not companies and users or sales person. Parent company, distributor 108 in FIG. 4A and FIG. 4B can assign another VAR and set attribution on sale by child parties. Upon distributor 108's needs, the company 108 can personalize the child company's status view. In this regards, VAR can be nested multi-level deep.

A seller's channel partner has an incumbent relationship with an end-customer, and any transactions from the end-customer should be automatically attributed to the incumbent partner. Further, parent company VAR 108 can make ecommerce company like 412 and set attribution logic based on effective dates of relationship by child. Upon parent company's needs, the VAR 108 can personalize the child company's status view 412, 414, 416, 148, etc. In this regards, ecommerce companies can be nested multi-level deep.

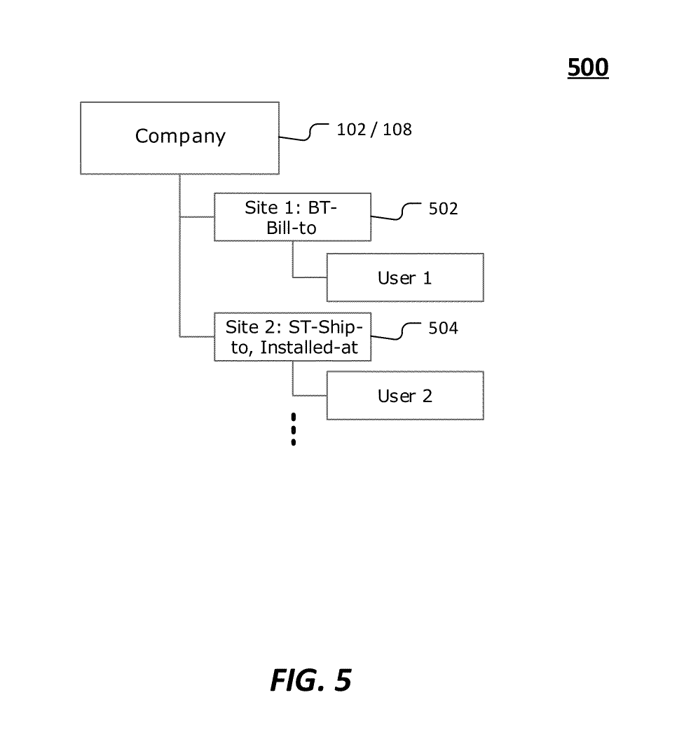

Further, a seller, end-customer, or channel partner company can have multiple sites. In FIG. 5, the hierarchical data model can allow this function. In the multiple sites function, each sites can have “uses”. The “uses” may be the activities such as bill-to 502, ship-to 504, installed-at 504, etc., and users or sales person serve as “use-contact”. The “use-contact” will be provided by sites as a default but other access permissions will be set-ups by seller. A company 102 or 108 builds end-customer sites upon “uses”. The sites can be used to limit scope of visibility and access permissions to users under a given site. The company 102 or 108 also can set-up the visibility to child stats and activity 502 or 504 along with channel partner's visibility to end-customer states and seller's contact information.

Therefore, party management system 206 operates relationship-based attribution management. Using relationship-based commerce attribution rather than transactional based attribution, events or commerce transactions can automatically take a transaction originating with a child party and also attribute it to a parent party of that child for the purpose of commission or compensation, or to provide performance viability to the parent.

This party management system (group-rules system) 206 associates multiple parties into one or multiple groups and use the groups for defining various commerce business rules such transaction types allowed for a certain party, compensation rates for a party, and/or category designation of party through interacting between party attribution engine 207 and relationship management engine 208. In combined with party attribution engine 207 and relationship management engine 208, the module 206 provides a highly flexible and scalable means to implement the business policies and programs and apply them at scale based on the parties involved on a transaction.

The party management system 206 further has party-specific commerce business rules to support the ability to use common industry rules supported by the system and business-defined custom rules at the individual party level. These rules support highly-specific configuration to address unique requirements of a given party, inclusive of automated, transaction and event-driven messaging and communication, as well as rules that restrict or permit certain transaction types based on the role of a specific party in a group or a hierarchy.

### Universal Event Management

In FIG. 2 event management system 209 operates fully configurable event-based tracking that can model any transaction flow or customer lifecycle, including the provision of rules for event sequencing, dependency, customizable triggers, and “anywhere” support for tracking events.

The event management system 209 is comprised of three major components: organization & relationship model and program model using event attribution engine 210, and event tracking engine 211. The event tracking module 211 has event list of all potential events which a client may want to manage. The event is the recording of a commerce-related activity that may originate from the commerce system 205, another third party system 108, manually created system 220 by users in 104, or automatically created by the system 220 upon event made. The commerce activity may be a user-driven transaction such as click on an advertising banner or the completion of sales or filling-out a portion of a sign-up form by end-customer 104. Also the activity may be a series of transaction resulting in reaching a particular lifecycle stage in a transaction flow, or represent the status of a party managed by the system such as capturing a commerce client reaching a stage in the customer lifecycle.

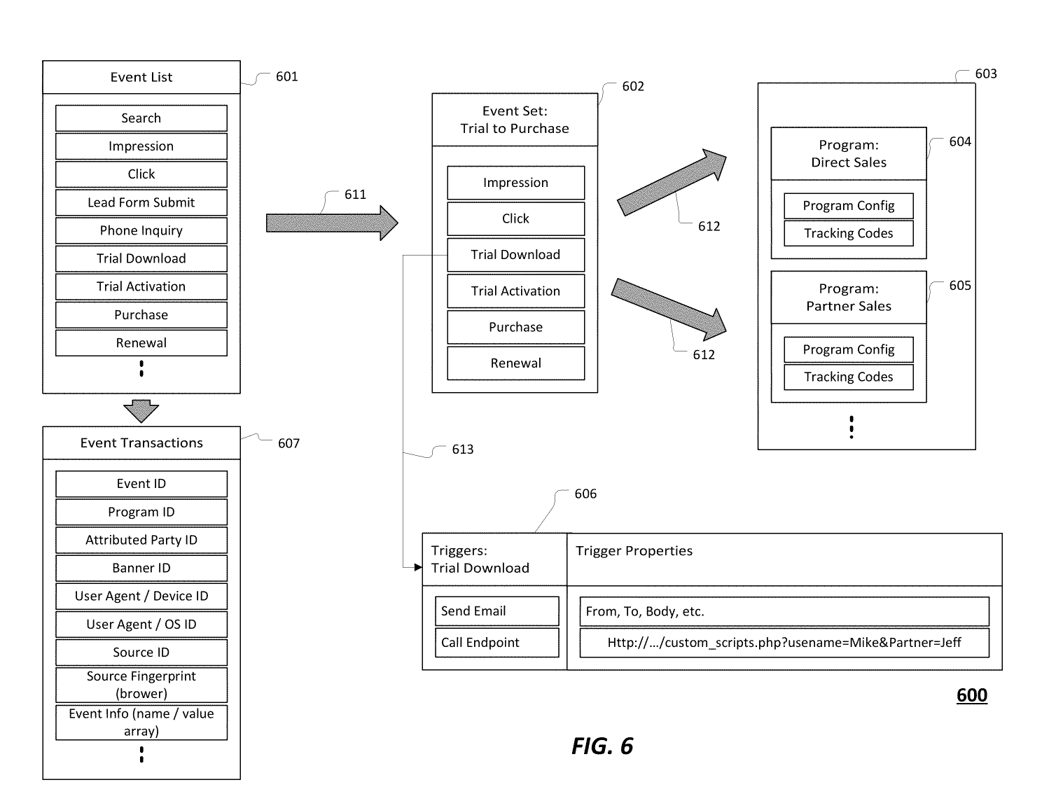

The FIG. 6 illustrates sample event list and transaction to show implementation of event management. The event list 601 and sub-set 602 may have any types of event can be added. The event list 601 acts like a “catalog” that can be used to build a specific set of events that reflect a transaction process or related set of actions such as search, click, purchase, etc. The event list 601 is a set of standard event structures for capturing common commerce events and transactions. It includes but not limited to transactions such as impressions, clicks, leads, sales, renewals, returns and reversals. The event list 601 also can be personalized custom event list. This custom list can be any type of activity or transaction and is configured by a seller for its specific needs. For example, a software firm may want to track activates following the initial sale such as an upgrade installed by the customer, or a customer deactivating their maintenance.

The custom event allows the configuration of any business process, and the capture and association of related events across multiple parties. The event data are stored to and retrieved from 234 from Database 215 in FIG. 2. A reporting can be aggregated at the event list level 601 in FIG. 6. A special type of events that calculates a commission based on configurable rules, and is attached to one more other events. Any event, such as a sale or a custom event list, can spawn the execution of multiple commission events such as a calculating the commission amount for both a sales person and third-party company involved on a single sale transaction.

In the custom event function, the system has a set of user-configurable attributes in event attribution engine 210 in FIG. 2 that specify a set of data which can be associated with a specific event, or an event type, which is them inheritable by instances of a specific event. These attributes make it possible for the business to customize the data captured on any event.

Upon setting events, each event can have one or more triggered actions. A triggered action take place based on conditions in the event, and may be used for a variety of different dynamic actions such as executing another event, sending an email message 606 in FIG. 6, or calling a custom HTTP end-point which executes custom logic. Each trigger can be configured to capture and use a set of values in which value is assigned to a specific property. An example 606 is a triggered action which is an email message, the properties of which are “from” and “to”, each of which accept an email address as a value.

An instantiation of an event as a triggered action 606, which automatically inherited an event's extensible attributes as trigger properties for the even in question. A set of configurable rules in event attribution engine 210 in FIG. 2 applied to an event. There include dependency rules, which dictate an allowable sequence of the events, as well as rules which restrict which parties may invoke an event.

To manage events, the event attribution engine 210 in present invented system 220 generated event model. Referring to FIG. 6 the system creates event catalog 601, which is the list of events that a business has created or activated for their instance of the system. This catalog 601 serves as the “menu” from which individual events of any type are selected for inclusion in an event set 602. The event set 602 is a set of events from the event catalog 601 which may represent a series of transactions or statues in a specific business process, in a party lifecycle, or a combination of the two. An event set is applied to a specific channel commerce program 603. The programs 603 stipulates the events that are available to the program for processing. When applied to a channel commerce program 603, the event set inherits the business rules defined for that program.

Beyond applying in a defined event set 602 to a program, the seller can create additional specific events on a program 603 itself, augmenting or truncating the event set 502, thereby defining that program to meet the needs of a specific business process or commerce transaction that program may support.

At the event set 602 level in FIG. 6, the event tracking engine 211 in FIG. 2 operates sequence events, optionally sets pre-requisites, defines event as commissionable or not, designates triggers on events and define extended attributes on events. The engine 211 instructs any event to execute fully customizable action to define “triggered actions” 606. A trigger can conditionally start based on data passed when the event is tracked. For example, “Call Endpoint” trigger type in 606 supports fully customizable actions that can be used for integration custom functions, attribution enrichment, and analytics. The trigger can use data passed 613 in the event to dynamically set trigger properties in 606.

The triggers can be multiple in an event. An event set 602 can be applied to multiple programs 603, leveraging program tracking rules in event tracking engine 211. Once applied to a program triggers can be further refined for a specific program 603. At the program level 603, the event tracking engine 211 generates tracking code for each events. At the program level 603, event management system 209 generates performance report by program or across programs by common event set.

The tracking code in 604 or 605 has multiple formats such as link, pixel, java scripts tag, server-side call (API), or code library. Events can be invoked over HTTP via RESTful API using any programming language, through a pixel image source, or via HREF (hypertext reference) in a user clickable link. An FTP-enabled sub-system, event states connector that consumes files of a defined structure to automatically import event information in batches.

Also, events can be set manually by system 220 users such as sellers or channel partners. The present invented system 220 user manually can enter the event value or upload files via access through network 204 and connection 223, 224 and 225 in FIG. 2.

Based on event list 601, event attribution engine 210 in FIG. 2 generates event transactions code 607. Using event transactions code 607, when an event is tracked, the event captures by event tracking engine 211 both defined source data and interaction-point source data from attribution. Triggers can be used to enrich attribution data. For example, using the source fingerprint, the engine can find a previously tracked related event and update the current event with additional information. An event transaction can return a response code that can be consumed by the browser or source environment.

For example, in case of transaction life cycle software, seller wants to understand buyer activity from initial engagement through trial, purchase and renewal. The impression, click and trail download originated from end-customer's activities, and trial activation and purchase from commerce system are defined as events. Those events are managed in event management system 209. In case of customer lifecycle software, seller wants to support renewal, entitlement change and cancellation. The purchase, renewal and entitlement change are defined as events.

Event attribution engine 210 can represent consumers, companies, organization within companies, contacts at companies and hierarchical relationships that support multi-party attribution, flexible categorization, and performance reporting using organization & relationship model. Through interface 232 in FIG. 2 between party management system 206 and event management system 209, the party management system 206 sends the data of parties to the event management system 209. Upon receiving the data, the event management module 209 operates for mapping transaction defined by program model by parties. Using program model 603, event management system 209 organizes and collects related transactions into a business process, defines rules for managing permitted or restricted transactions, houses creative assets and links, and supports a performance reporting.

### Channel Commerce Program

A channel commerce program 603 is a data object that aggregates a specified set of events based on attributes which has defined by the seller. A program is comprised of an instance of an event set which in turn defines all of the event activities or transactions that will be associated to a program upon their recording by the system. A program materials is a set of information that is exposed to both the seller and the channel partners that describes the program, houses the program's digital assets, and stipulates the commission rates and structure for compensating partners of events that the seller deems commissionable. A program-party association program can be configured in a manner that supports limiting a defined list of individual parties or a configured party group to access the program materials or record event transactions against the program.

A program digital assets is a set of digital content in any supported format that can be made available to the channel partners or sellers for the purpose of motivating action by and recording the actions of an end-customer. Examples include image files text links, HTML, video, QR (or other machine scan-able) codes, pixel codes, Java scripts or web-service call that at end-customer may click on, may inadvertently invoke when arriving at a web page, or explicitly invoke at a given point in a business process. Such actions by the end-customer result in the recording of the event Upon programmatic publishing of the digital assets to the channel partners either through a web page hosted on behalf of the seller using the system (a partner portal), through an email tool provided by the system, or through use of an API, the system automatically creates a partner-specific instance of the asset, associating that published asset to a specific channel partner. The publishing process embeds the partner's attribution identifier, the program identifier, and the event identifier(s) into the code that represents the asset itself.

Program business rules is a set of configurable rules which are set on each program and used to apply conditions at the time of event transaction processing, resulting in a user-specific treatment of an event. Examples of rules include mechanisms for authorizing or rejecting transactions based on their source or origination, automatically removing duplicate events, and setting user-defined limits on the quantity of events that can be recorded for a specific partner, by a specific type of transaction, and over a user-definable period of time.

### Attribution and Channel-Integrated Commerce

The term “attribute” or “attribution” refers to the process of associating specific transactions with parties, programs, and events in real time as the transactions are processed by the system. The attribution includes incoming, in-commerce and post-sales attribution. The incoming attribution is captured on a transaction by the system, processed against a party, a program, and event business rules, prior to then directing the end-customer to channel-integrated commerce program. The in-commerce attribution is captured after the end-customer has already engaged with the channel-integrated commerce system. This attribution method uses information that is captured by the commerce system, such as the contents of the shopper's cart, to either automatically attribute a partner or program to an end-customer's actions, or to present the end-customer with a list of partners or programs from which to select. The post-sale attribution is captured following the sale using either a user-configured event set and corresponding programmatic triggered actions, manually by the seller, or automatically by the seller system, using an outside program which invokes the system's APIs or other method for invoking events.

The “channel-integrated commerce” refers to the process of using attribution to automatically apply a set of user-defined rules to the commerce process that are specific to the nature of online commerce the seller is engaging in with the parties. For example, a given channel partner may only be authorized to promote a certain subset of the sellers products. At the time of transaction processing, the system uses the attribution identifier by party management system 206 in the digital assets to look-up and then programmatically expose to the channel-integrated commerce system a large, configurable array of information that includes all attributes of the partners programs and events that are stored in the system.

### Partner-Assisted Selling

Partner-assisted selling refers to a process through which the partner completes some portion of the order on the commerce system on behalf of the end-customer, and then engages with the end-customer to complete the process, providing some information that is needed for the order to be fulfilled and for the end-customer to accept entitlement to the product purchased. Partner-assisted selling process includes auto-attributed commerce cart, template carts, single-point buy and resell, and related activities from sales transaction.

Auto-attributed commerce cart allows the partner, within the partner portal, to add items (at a specified quantity) to the commerce shopping cart, save the shopping cart, and generate a URL link or digital asset that will automatically associate an order placed with that shopping cart to the partner for attribution and commissioning. Upon receiving and clicking on the link from the partner, the end-customer is taken directly to the shopping cart where they can complete the purchase and check-out process.

Templated carts extend the capability of auto-attributed commerce carts to allow the partner to create template versions of commerce carts, save those templates, and then upon need, instantly generate a URL link or digital asset for use by a specific end-customer for a specific transaction. This provides the partner with the efficiency of creating templates for frequent, similar end-customer orders, rather than a configuring an order for each request. Additionally, this feature allows the partner to implement standard or consistent discounts for certain end-customers

Single-point buy and resell (SPBR) allows a partner to use a single commerce system combined with an automated, continuous transaction flow across a multiparty lifecycle to drive the sale of goods to end-customer. Throughout this continuous flow, a single, combined “Commerce and Merchant of Record Service” acts as the central point through which all parties on a transaction purchase and fulfill utilizing ecommerce for processing of all transactions and integrated “Party Netting” to automate financial settlement and payments. This flow combines with 1) commerce and merchant of record service, 2) private partner store, 3) settle and quote, 4) end-customer purchase and pay and 5) party netting: following:

Commerce and merchant of record service is a service through which the seller purchases among Commerce Store capability, Merchant or Record (MOR) and Seller of Record (SOR) services. This service allows the provider to, on the seller's behalf, act as MOR/SOR, and perform independent financing, accounting, payment, and other back-office functions to support the purchase of the seller's products.

Private partner stores is a specific, “private”, version of a commerce store is created, with purchase plans and discounting in alignment with the reseller agreement between the partner and the seller, and embedded in the system's partner portal. Partners use this store to make a purchase for a specific end-customer transaction with the intent to resell the items purchased to the end-customer in question. This is a conventional commerce process in which the Reseller acts as a buyer with the seller.

In settle and quote, upon settling payment for the transaction with the seller and acceptance of goods by the reseller, the reseller can then generate a quote for the end-customer from the settled order, password protect the quote, and forward a secured URL link or digital asset directly to the end-customer. In generating the quote the reseller is prompted to adjust pricing. This pricing can be set in a manner in which a reseller can configurably display the MSRP (Manufacturer suggested retail price) and the end-customers' buying price, or to reflect other cosmetic merchandising. The reseller can make other order adjustments.

Other order adjustments refer to changing anything other than the line-item unit price of purchased goods or services on a quote. Examples include adjusting quantities, adding items or removing items.

In the step of end-customer purchase and pay, upon receipt of a secured URL link or digital asset, the end-customer can click, arrive at the quote, pre-embedded into the commerce system's cart, review and accept terms of sale or terms of use, complete payment and check-out. Where applicable, the end-customer can also take digital fulfillment of goods.

The party netting process through which the commerce provider nets the amount owed vs. the amount paid between parties over a defined period of time as the transactions are settled against an aggregated multi-party balance sheet and through a centralized payment & remittance and process. Party netting also handles the financial adjustments for amounts owed and due between parties based on “Other order adjustments” which the reseller may have made when creating the quote.

### Commission-Funded Discounting

Commission-funded discounting (CFD) is a method for using a commission rate (and the currency value it represents) on an order placed through the commerce system to act as a promotional budgetary mechanism that allows a Partner which would receive a commission payment on that transaction to instead exchange all or a portion of that commission to offer a discounted price to the end-customer placing an order. Through this method, channel partner system 220 employs commission-to-discounting relationship, discount-to-commission netting, discount request management and discount code creation and deployment.

The CFD method employs commission-to-discounting relationship. For a given party, program, event or combination of the three, a commission rate is specified by the Seller, payable to the Partner, for the successful conversion of a purchase. This commission rate is used by the CFD method as a budget amount within which the partner can specify a discount amount. For example, on a the sale of a $100 item which bears a program based commission of 30% to the channel partner, the partner has the option to offer a purchase price discount to the end-customer of up to $30.

The CFD further employs a discount-to-commission netting. Upon completion of the purchase event transaction, the discount amount offered by the Partner and claimed by the end-customer is netted against the amount of commission that would be paid to the partner. For example, if the Partner had a 30% percent commission available on the $100 purchase, and offered a $25 discount to the end-customer, the channel partner's commission would be reduced from $30−$25=$5 commission payable to the partner.

Because the amount payable to the partner has been reduced at the partner's request, the seller does not experience a loss of or reduction of revenue. The seller may, at its option, require the partner to apply for a certain discount which requires approval by the seller via an integrated workflow process, or optionally, the seller may configure the system to “auto-approve” all discount requests within the partner's budgetary commission amount.

Within the web portal used by the seller's partners, a Partner can enter a requested discount amount, providing any data required by the seller. Upon receiving approval, the system automatically integrates with the commerce system's merchandising module to create the discount with any applicable rules for the allowable use of the discount. For example, the discount may be configured for “one use” only. Once the merchandising module has processed the request, the discount code is returned to the partner in the partner portal, and automatically integrated into a link or other digital asset that the partner can provide to the end-customer. Upon clicking on the link or digital asset, the code is automatically provided to the commerce system, which applies the discount at the time of payment.

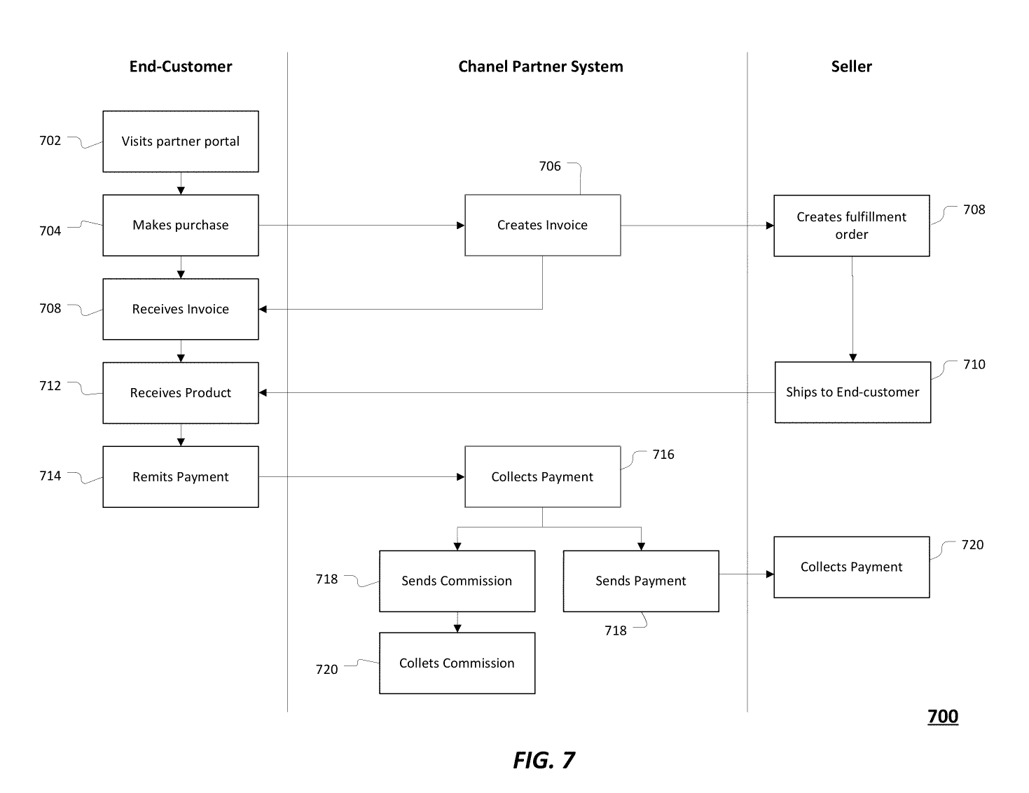

For example of workflow with transaction of order in FIG. 7, end-customer visits partner portal 702 and end-customer makes purchase 704, and then party management system 206 in the present disclosed system 220 gathers and collects partner attribution and send trigger to event management system 209. When a commerce transaction is formed FIG. 7, party management system 206 and event management system 209 interacts to process party attribution and create event “order”. And then with collecting and mapping attribution of party and event, party event management system 209 interacts with channel commerce system 212. The accounting engine 214 in channel commerce system 112 creates an invoice 706 and send to end-customer and seller. The end-customer and a seller can receive this invoice through commerce system 205. After receiving invoice from channel management system 220, seller creates fulfillment order 708 and ships ordered product or service to end-customer 710. Upon receiving product or service 710, end-customer remits its payment 714. Then channel partner system 220 gets the payment 716 information from commerce system and transmitted it to accounting engine 214 in channel commerce engine 212. This engine 214 automatically calculates partner commission based on already given attribution and rules by parties and event management system 209. According to the result of the calculation, channel partner system 220 sends commission to partner 718 and payment to seller 718 through interface with the partner and seller. Then partner receives commission and seller receives payment 720.

Through this transaction, the accounting engine 214 calculated the amount based on events which attributed in event management system 209. The calculated commission is related to discount rate of each channel partners. The event attribution engine have the specific attribution that related to each parties and transaction. From the data from event management system 210, accounting engine 214 receives mapped discount rate upon partner and transaction. Then, the accounting engine 214 sends the value to each resource control system of partners and seller to provide integrated financial reconciliation upon completed transaction and calculating commission by discount. Further, integrated payment service in accounting engine 214 performs payment to channel partner in given transaction on the behalf of seller. Therefore, channel partner and seller can allow efficiency to manage commercial transaction.

### Dynamic Storefront Co-Branding

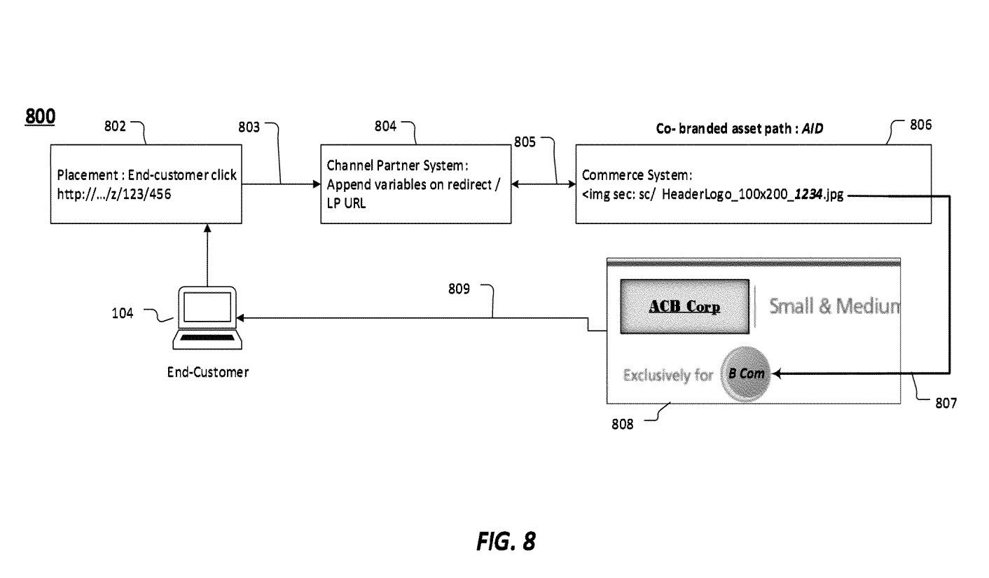

For leveraging the synergies between commerce transaction through commerce system 205 and present disclosed channel partner system 220, the system 220 can allow dynamic co-branding approaches through co-branding engine 213. Party management system 206 sends channel partner's attribution through 237 to channel commerce system 212. FIG. 8 illustrates simplified flow diagram of dynamic co-branding function. Based on incoming channel partner attribution, channel commerce module dynamically append variables to redirect incoming URL 802 from end-customer 801, sends the co-branding image 808 to database 215 in FIG. 2 for saving, and sends back revised URL 806 with image 808 to end-customer 801. Then end-customer can see and access co-branded site by web-accessible system 801. In this operation, the channel partner entities can be recognized by AID which is generated in party management system 206 in FIG. 2. The co-branding engine 213 render appropriate store, theme, and assets on the store for commerce transaction.

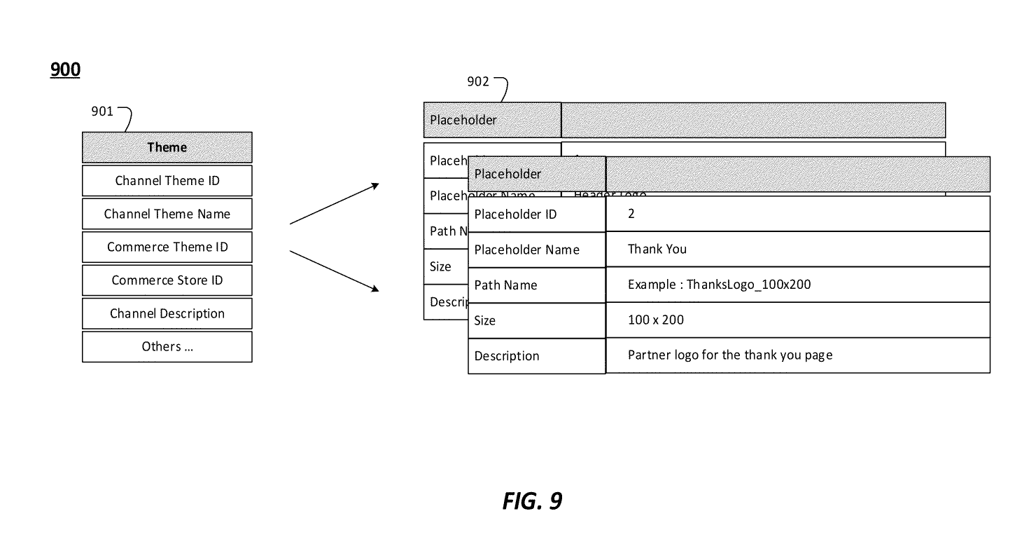

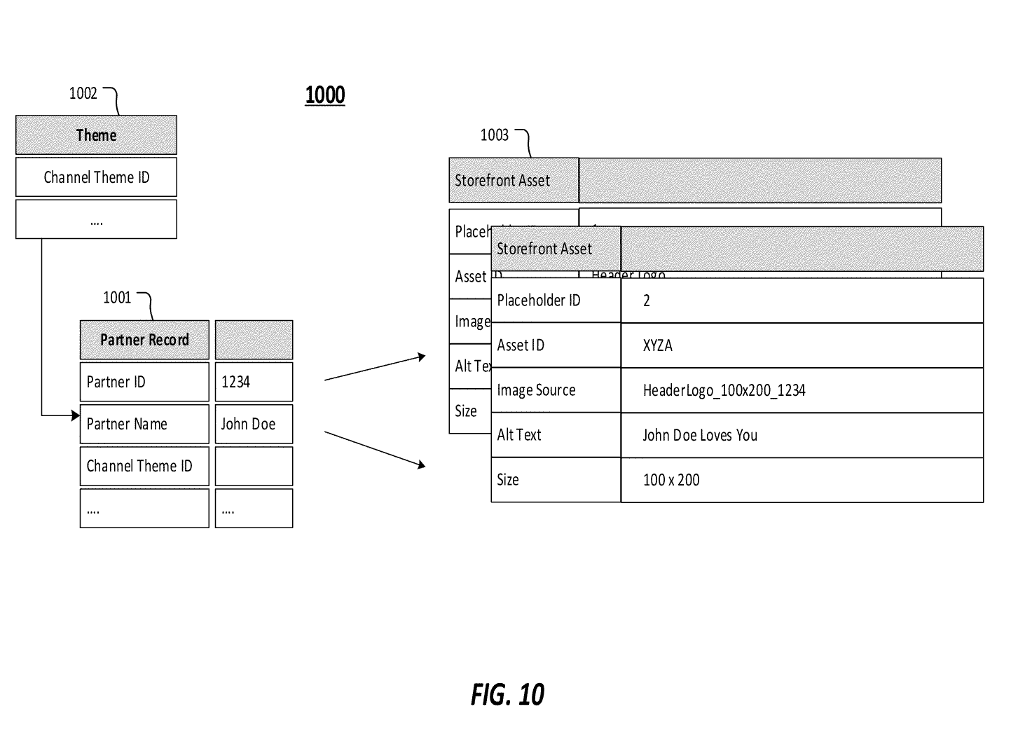

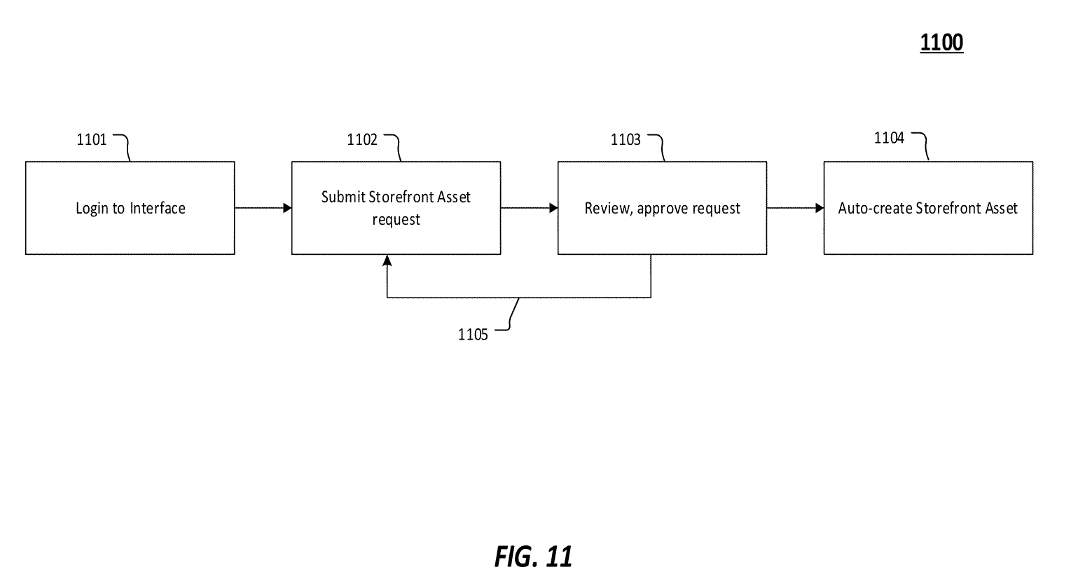

To implement dynamic storefront co-branding, co-branding engine 213 in FIG. 2 processes by operating three major methods. One is the themes and placeholders in FIG. 9, the other is the partner assets FIG. 10, and the rest one is permissions and workflow FIG. 11. Themes 901 and place holder 902 contain a name, theme id and a private store id. Theme can have multiple placeholders 902. Each placeholder 902 has a set of attributes that define allowable content such as file type, image size, etc. A seller can define multiple themes, provide attributes for the theme that correspond to its specific commerce setting, and define placeholders for each theme.

Through co-branding engine 213, channel partner system 220 provide the implementation of storefront assets by simply designating an image source “placeholder” in the appropriate storefront real estate location based on incoming partner attribution (AID and partner ID). By passing identifiers for themes or private stores to commerce system with incoming traffic. It provides seller the ability to designate “placeholders” for storefront assets. A placeholder represents a “container” which partner assets will be associated with. Further, this engine gives partners the ability to submit storefront assets through the partner interface for review, approval, or deployment, and understand that status of a submission. FIG. 11 illustrates “partner edit request” workflow to allow clients to review, approve, approve/edit, or reject a storefront asset submission, capturing notes and reason codes.

Partner record 1001 in FIG. 10 is a sample of partner asset. A channel partner has a “theme” 1002, associated with their partner record 1001, and can have content for each placeholder in the theme associated to their record. A partner record 1001 is associated to a channel partner theme 1002, granting access to a set of placeholder for the partner. The partner can submit a creative asset 1003 for each placeholder. Once approved, the asset is referenced based on the path name and the partner identifier.

Sellers can designate whether or not a channel partner is permitted to have storefront content and which theme a partner can access. Permitted channel partner can submit an asset, which requires client review and approval. In FIG. 11, a channel partner 108 in FIG. 2 login to interface 1101 and submit storefront asset request 1102 and co-branding engine 213 in FIG. 2 review and approve request upon rules and then the channel partner is notified and store storefront asset 1003 in FIG. 10 in database 215 in FIG. 2. If the submission request is declined, then the channel partner goes to 1102 to retake the workflow FIG. 11.

The individual components of the disclosed system and method are necessarily composed of a number of electronic components. Ecommerce systems are hosted on servers that are accessed by networked (e.g. internet) users through a web browser on a remote computing device. One of ordinary skill in the art will recognize that a “host” is a computer system that is accessed by a user, usually over cable or phone lines, while the user is working at a remote location. The system that contains the data is the host, while the computer at which the user sits is the remote computer. Software modules may be referred to as being “hosted” by a server. In other words, the modules are stored in memory for execution by a processor. The ecommerce application generally comprises application programming interfaces, a commerce engine, services, third party services and solutions and merchant and partner integrations. The application programming interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, end users may access the ecommerce system from a computer workstation or server, a desktop or laptop computer, a mobile device, or other electronic telecommunications or computing device. A commerce engine comprises a number of components required for online shopping, for example, customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wishlist, saved cart, entity, security, throttle and more). Third party services and solutions may be contracted with to provide specific services, such as address validation, payment providers, tax and financials. Merchant integrations may be comprised of merchant external systems (customer relationship management, financials, etc), sales feeds and reports and catalog and product feeds. Partner integrations may include fulfillment partners, merchant fulfillment systems, and warehouse and logistics providers. Any or all of these components may be used to support the various features of the disclosed system and method.

An electronic computing or telecommunications device, such as a laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on sub-components of the computer or device system such as a keyboard or disk drive, but may also be electronic communications between devices connected by a network, such as a wide area network (e.g. the Internet) or a local area network. The memory may include random access memory (RAM) or similar types of memory. Software applications, stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired. Where performance is impacted, additional processing power may be provisioned quickly to support computing needs.

A secondary storage device may include a hard disk drive, floppy disk drive, CD-ROM drive, DVD-ROM drive, or other types of non-volatile data storage, and may correspond with the various equipment and modules shown in the figures. The secondary device could also be in the cloud. The processor may execute the software applications or programs either stored in memory or secondary storage or received from the Internet or other network. The input device may include any device for entering information into computer, such as a keyboard, joy-stick, cursor-control device, or touch-screen. The display device may include any type of device for presenting visual information such as, for example, a PC computer monitor, a laptop screen, a phone screen interface or flat-screen display. The output device may include any type of device for presenting a hard copy of information, such as a printer, and other types of output devices include speakers or any device for providing information in audio form.

Although the telecommunications device, computer, computing device or server has been described with various components, it should be noted that such a telecommunications device, computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, including hard disks, floppy disks, or CD-ROM; a non-transitory carrier wave from the Internet or other network; or other forms of RAM or ROM. Furthermore, it should be recognized that computational resources can be distributed, and computing devices can be merchant or server computers. Merchant computers and devices (e.g.) are those used by end users to access information from a server over a network, such as the Internet. These devices can be a desktop PC or laptop computer, a standalone desktop, smart phone, smart TV, or any other type of computing device. Servers are understood to be those computing devices that provide services to other machines, and can be (but are not required to be) dedicated to hosting applications or content to be accessed by any number of merchant computers. Web servers, application servers and data storage servers may be hosted on the same or different machines. They may be located together or be distributed across locations. Operations may be performed from a single computing device or distributed across geographically or logically diverse locations.

Client computers, computing devices and telecommunications devices access features of the system described herein using Web Services and APIs. Web services are self-contained, modular business applications that have open, Internet-oriented, standards-based interfaces. According to W3C, the World Wide Web Consortium, a web service is a software system “designed to support interoperable machine-to-machine interaction over a network. It has an interface described in a machine-processable format (specifically web service definition language or WSDL). Other systems interact with the web service in a manner prescribed by its description using Simple Object Access Protocol (SOAP) messages, typically conveyed using hypertext transfer protocol (HTTP) or hypertext transfer protocol secure (HTTPS) with an Extensible Markup Language (XML) serialization in conjunction with other web-related standards.” Web services are similar to components that can be integrated into more complex distributed applications.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application, while maintaining substantially the same functionality without departing from the scope and spirit of the present invention.

What is claimed is:

1. A computerized method comprising:
managing and storing relationships between a plurality of parties, the parties including at least a seller and a partner;
tracking at least one event associated with the parties;
producing an event complete indication upon completion of an event;
accounting for the completed event based on the event and the relationship between the parties; and
outputting a result from the accounting.

2. The computerized method of claim 1 providing a portal for communicating the result form the accounting to the plurality of parties associated with the event.

3. The computerized method of claim 1 wherein tracking at least one event associated with the parties includes tracking a plurality of events for a plurality of parties.

4. The computerized method of claim 1 wherein accounting for the completed event based on the event and the relationship between the parties includes calculation of commissions payable to at least some of the parties.

5. The computerized method of claim 1 wherein providing party relationship data model includes a plurality of parties and hierarchical structure to implement multiple tiers.

6. The computerized method of claim 1 wherein distributing accounting results to parties implements revenue allocation, commission calculation and payment distribution

7. The computerized method of claim 1 generating a plurality of event sets associate with each executable programs to trigger.

8. The computerized method of claim 1 wherein accounting for the completed event based on the event and the relationship between the parties includes distribution of commissions payable to and sales payment to at least some of the parties.

9. The computerized method of claim 1 wherein providing party relationship data model provides party-specific commerce business rules including restrict or permit certain transaction types.

10. An e-commerce computer system comprising:
a party management module for managing and storing relationships between a plurality of parties associated with at least one event;
an event management module for tracking at least one event associated with the parties, the event management module producing an event complete indication upon completion of an event;
a channel commerce module that receives the indication of the completion of the event, the channel commerce module accounting for the completed event based on the event and the relationship between the parties; and
a portal for communicating with at least the parties associated with an event, the channel commerce module outputting a result from the accounting to the parties associated with the event.

11. The e-commerce computer system of claim 10 wherein:
building data model that setting up the individual or group roles based on nature of specific commerce transaction;
generating attribution identifiers, one is a system-generated unique identifier and the other is seller-defined identifier;
building mapping data model between roles and transactions under the nature of specific transaction, and between roles and parties under the type of parties;
building hierarchical data model among parties; and
building hierarchical data model implementing multiple sites for entities to define rules and roles of parties.

12. The e-commerce computer system of claim 10 wherein:
generating event list that a set of events that created by system or users;
storing and distributing events during commerce transaction;
collecting event identifiers interacting with a party management module;
building mapping data model between event and parties' attribution;
tracking a plurality of events based on transaction type and parties; and
triggering executable computerized program associated with events.

13. The e-commerce computer system of claim 10 wherein:
mapping event and associated accounting program based on parties relationship;
calculating of commissions payable to at least some of the parties;
distributing at least some of the accounting results to the parties;
allocating a portion of revenue derived through the parties at the end of transaction event;

14. The e-commerce computer system of claim 10 wherein
receiving at least one accounting result including commission calculation; or personalized web design result;
employing to provide at least a portion of events associate with transaction;
receiving at least a plurality set of events information corresponding to the sales transaction;
generating and storing a plurality of web designs as a plurality of themes;
mapping a plurality of themes associated with the parties' request;
processing editing request by parties to add, modify, or change of the web designs;
changing or appending variables to original web URL to redirect parties to co-branding web sites:

15. The e-commerce computer system of claim 10 further comprising:
a processor;
a memory coupled with the processor, wherein the party management module, the event management module, and the channel commerce module operate on the processor using the memory;
a network communication device configured to exchange data communications through a communication network; and
a storage device accessible to the processor.

16. A machine-readable medium providing instructions that, when executed by a machine, cause the machine to perform operations comprising:
managing and storing relationships between a plurality of parties, the parties including at least a seller and a partner;
tracking at least one event associated with the parties;
producing an event complete indication upon completion of an event;
accounting for the completed event based on the event and the relationship between the parties; and
outputting a result from the accounting.

17. The machine-readable medium of claim 16 further comprising an instruction that causes the machine to generate, collect, store, and distribute a plurality of events for a plurality of parties.

18. The machine-readable medium of claim 16 wherein the accounting for the completed event includes a determination of commissions payable to the parties associated with an event.

19. The machine-readable medium of claim 16 wherein the managing and storing relationships between a pluralities of parties using hierarchical data model to generate multiple relationship among parties.
